(19) United States
(12) Patent Application Publication
(10) Pub. No.: US 2023/0230161 A1
(43) Pub. Date: Jul. 20, 2023

(54) METHOD AND SYSTEM FOR PREDICTIVE ANALYTICS USING MACHINE LEARNING MODELS

(71) Applicant: JPMorgan Chase Bank, N.A., New York, NY (US)

(72) Inventor: Ranjith KALUVALA, Cranbury, NJ (US)

(73) Assignee: JPMorgan Chase Bank, N.A., New York, NY (US)

(21) Appl. No.: 17/648,478

(22) Filed: Jan. 20, 2022

(51) Int. Cl. G06Q 40/06

(52) U.S. Cl. CPC G06Q 40/06

(57) ABSTRACT

A method for facilitating real-time predictive analytics of hedge ratios is disclosed. The method includes aggregating market data from a source, the market data including raw data for financial instruments; detecting, in real-time from the market data, an indication, the indication relating to a change in the financial instruments; generating a structured data set for each of the financial instruments based on the market data; identifying a model for the financial instruments based on the structured data set; and determining, in real-time using the model, a hedge ratio and a corresponding duration based on the structured data set.

### BACKGROUND

### 1. Field of the Disclosure

This technology generally relates to methods and systems for predicting hedge ratios, and more particularly to methods and systems for facilitating real-time predictive analytics of hedge ratios and corresponding durations by using machine learning models.

### 2. Background Information

Many financial services companies rely on conventional models such as, for example, empirical duration models to determine hedge ratios for financial instruments such as, for example, to be announced (TBA) mortgage-backed securities. Often, changes in the hedge ratios may impact risk exposures and duration of the risk exposures for the financial instruments. Historically, implementation of the conventional models has resulted in varying degrees of success with respect to facilitating real-time predictive analytics of hedge ratios and corresponding durations when market movements occur.

One drawback of using the conventional models is that in many instances, the hedge ratios and corresponding durations may not be determined based on real-time changes in other hedged financial products such as, for example, treasury instruments and swap instruments. As a result, the hedge ratios and corresponding durations may only reflect past conditions. Additionally, future impacts of market movements may not be anticipated by using the conventional models.

Therefore, there is a need to facilitate real-time analytics of market movements by using machine learning models to predict hedge ratios and corresponding durations.

### SUMMARY

The present disclosure, through one or more of its various aspects, embodiments, and/or specific features or sub-components, provides, inter alia, various systems, servers, devices, methods, media, programs, and platforms for facilitating real-time predictive analytics of hedge ratios and corresponding durations by using machine learning models.

According to an aspect of the present disclosure, a method for facilitating real-time predictive analytics of a plurality of hedge ratios is disclosed. The method is implemented by at least one processor. The method may include aggregating market data from at least one source, the market data may include raw data for a plurality of financial instruments; detecting, in real-time from the market data, at least one indication, the at least one indication may relate to a change in the plurality of financial instruments; generating at least one structured data set for each of the plurality of financial instruments based on the market data; identifying at least one model for the plurality of financial instruments based on the at least one structured data set; and determining, in real-time using the at least one model, at least one hedge ratio and a corresponding duration based on the at least one structured data set.

In accordance with an exemplary embodiment, the plurality of financial instruments may relate to a plurality of hedging financial products that are usable to offset a risk of adverse price movements, the plurality of hedging financial products may include at least one from among a treasury instrument and a swap instrument.

In accordance with an exemplary embodiment, the at least one source may include at least one from among a first-party data source and a third-party data source, the third-party data source may include at least one from among an exchange platform and a data service provider.

In accordance with an exemplary embodiment, the change in the plurality of financial instruments may correspond to a treasury price change.

In accordance with an exemplary embodiment, the at least one hedge ratio may correspond to at least one to be announced bond instrument, the at least one to be announced bond instrument may relate to a forward-settling of mortgage-backed securities trades.

In accordance with an exemplary embodiment, the method may further include retrieving historical data for each of the plurality of financial instruments based on a predetermined setting; identifying at least one feature that relates to the at least one hedge ratio and the corresponding duration from the historical data, the at least one feature may relate to a measurable characteristic of the at least one hedge ratio and the corresponding duration; determining at least one historical data pattern that relates to the at least one hedge ratio and the corresponding duration from the historical data; and training, by using the at least one feature and the at least one historical data pattern, the at least one model.

In accordance with an exemplary embodiment, the method may further include generating at least one graphical element, the at least one graphical element may include information that relates to the at least one hedge ratio, the corresponding duration, at least one threshold value that is associated with the at least one hedge ratio, at least one detected error, and intraday change data; and displaying, via a graphical user interface, the at least one graphical element.

In accordance with an exemplary embodiment, the method may further include determining whether the at least one hedge ratio and the corresponding duration exceeds a predetermined user threshold; generating at least one notification based on a result of the determining, the at least one notification may include information that relates to the at least one hedge ratio, the corresponding duration, at least one threshold value that is associated with the at least one hedge ratio, at least one detected error, and intraday change data; identifying at least one user notification preference from a corresponding user profile; and transmitting, via an application programming interface, the at least one notification based on the at least one user notification preference.

In accordance with an exemplary embodiment, the at least one model may include at least one from among a machine learning model, a statistical model, a mathematical model, a process model, and a data model.

According to an aspect of the present disclosure, a computing device configured to implement an execution of a method for facilitating real-time predictive analytics of a plurality of hedge ratios is disclosed. The computing device including a processor; a memory; and a communication interface coupled to each of the processor and the memory, wherein the processor may be configured to aggregate market data from at least one source, the market data may include raw data for a plurality of financial instruments; detect, in real-time from the market data, at least one indication, the at least one indication may relate to a change in the plurality of financial instruments; generate at least one structured data set for each of the plurality of financial instruments based on the market data; identify at least one model for the plurality of financial instruments based on the at least one structured data set; and determine, in real-time using the at least one model, at least one hedge ratio and a corresponding duration based on the at least one structured data set.

In accordance with an exemplary embodiment, the plurality of financial instruments may relate to a plurality of hedging financial products that are usable to offset a risk of adverse price movements, the plurality of hedging financial products may include at least one from among a treasury instrument and a swap instrument.

In accordance with an exemplary embodiment, the at least one source may include at least one from among a first-party data source and a third-party data source, the third-party data source may include at least one from among an exchange platform and a data service provider.

In accordance with an exemplary embodiment, the change in the plurality of financial instruments may correspond to a treasury price change.

In accordance with an exemplary embodiment, the at least one hedge ratio may correspond to at least one to be announced bond instrument, the at least one to be announced bond instrument may relate to a forward-settling of mortgage-backed securities trades.

In accordance with an exemplary embodiment, the processor may be further configured to retrieve historical data for each of the plurality of financial instruments based on a predetermined setting; identify at least one feature that relates to the at least one hedge ratio and the corresponding duration from the historical data, the at least one feature may relate to a measurable characteristic of the at least one hedge ratio and the corresponding duration; determine at least one historical data pattern that relates to the at least one hedge ratio and the corresponding duration from the historical data; and train, by using the at least one feature and the at least one historical data pattern, the at least one model.

In accordance with an exemplary embodiment, the processor may be further configured to generate at least one graphical element, the at least one graphical element may include information that relates to the at least one hedge ratio, the corresponding duration, at least one threshold value that is associated with the at least one hedge ratio, at least one detected error, and intraday change data; and display, via a graphical user interface, the at least one graphical element.

In accordance with an exemplary embodiment, the processor may be further configured to determine whether the at least one hedge ratio and the corresponding duration exceeds a predetermined user threshold; generate at least one notification based on a result of the determining, the at least one notification may include information that relates to the at least one hedge ratio, the corresponding duration, at least one threshold value that is associated with the at least one hedge ratio, at least one detected error, and intraday change data; identify at least one user notification preference from a corresponding user profile; and transmit, via an application programming interface, the at least one notification based on the at least one user notification preference.

In accordance with an exemplary embodiment, the at least one model may include at least one from among a machine learning model, a statistical model, a mathematical model, a process model, and a data model.

According to an aspect of the present disclosure, a non-transitory computer readable storage medium storing instructions for facilitating real-time predictive analytics of a plurality of hedge ratios is disclosed. The storage medium including executable code which, when executed by a processor, may cause the processor to aggregate market data from at least one source, the market data may include raw data for a plurality of financial instruments; detect, in real-time from the market data, at least one indication, the at least one indication may relate to a change in the plurality of financial instruments; generate at least one structured data set for each of the plurality of financial instruments based on the market data; identify at least one model for the plurality of financial instruments based on the at least one structured data set; and determine, in real-time using the at least one model, at least one hedge ratio and a corresponding duration based on the at least one structured data set.

In accordance with an exemplary embodiment, the at least one hedge ratio may correspond to at least one to be announced bond instrument, the at least one to be announced bond instrument may relate to a forward-settling of mortgage-backed securities trades.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating real-time predictive analytics of hedge ratios and corresponding durations by using machine learning models.

FIG. 4 is a flowchart of an exemplary process for implementing a method for facilitating real-time predictive analytics of hedge ratios and corresponding durations by using machine learning models.

FIG. 5 is a flow diagram of an exemplary process for implementing a method for facilitating real-time predictive analytics of hedge ratios and corresponding durations by using machine learning models.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

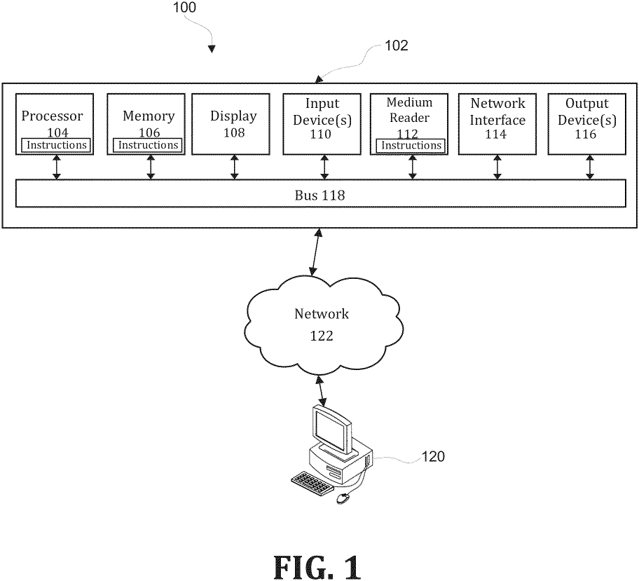

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating real-time predictive analytics of hedge ratios and corresponding durations by using machine learning models.

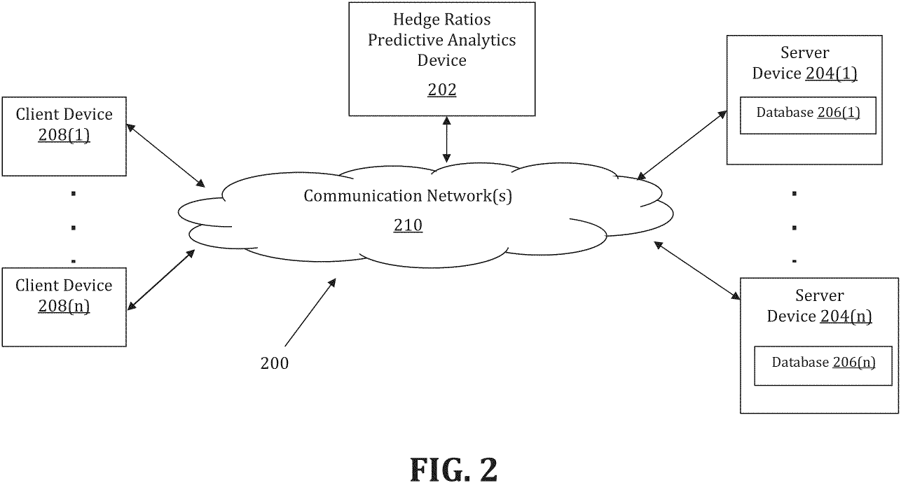

Referring to FIG. 2, a schematic of an exemplary network environment 200 for implementing a method for facilitating real-time predictive analytics of hedge ratios and corresponding durations by using machine learning models is illustrated. In an exemplary embodiment, the method is executable on any networked computer platform, such as, for example, a personal computer (PC).

The method for facilitating real-time predictive analytics of hedge ratios and corresponding durations by using machine learning models may be implemented by a Hedge Ratios Predictive Analytics (HRPA) device 202. The HRPA device 202 may be the same or similar to the computer system 102 as described with respect to FIG. 1. The HRPA device 202 may store one or more applications that can include executable instructions that, when executed by the HRPA device 202, cause the HRPA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the HRPA device 202 itself, may be located in virtual server(s) running in a cloud-based computing environment rather than being tied to one or more specific physical network computing devices. Also, the application(s) may be running in one or more virtual machines (VMs) executing on the HRPA device 202. Additionally, in one or more embodiments of this technology, virtual machine(s) running on the HRPA device 202 may be managed or supervised by a hypervisor.

In the network environment 200 of FIG. 2, the HRPA device 202 is coupled to a plurality of server devices 204(1)-204(n) that hosts a plurality of databases 206(1)-206(n), and also to a plurality of client devices 208(1)-208(n) via communication network(s) 210. A communication interface of the HRPA device 202, such as the network interface 114 of the computer system 102 of FIG. 1, operatively couples and communicates between the HRPA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the HRPA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and HRPA devices that efficiently implement a method for facilitating real-time predictive analytics of hedge ratios and corresponding durations by using machine learning models.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The HRPA device 202 may be a standalone device or integrated with one or more other devices or apparatuses, such as one or more of the server devices 204(1)-204(n), for example. In one particular example, the HRPA device 202 may include or be hosted by one of the server devices 204(1)-204(n), and other arrangements are also possible. Moreover, one or more of the devices of the HRPA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the HRPA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to market data, raw data, financial instruments data, indications, structured data sets, model, hedge ratio data, and corresponding duration data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the HRPA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the HRPA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the HRPA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the HRPA device 202, the server devices 204(1)-204(n), or the client devices 208(1)-208(n), for example, may be configured to operate as virtual instances on the same physical machine. In other words, one or more of the HRPA device 202, the server devices 204(1)-204(n), or the client devices 208(1)-208(n) may operate on the same physical device rather than as separate devices communicating through communication network(s) 210. Additionally, there may be more or fewer HRPA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

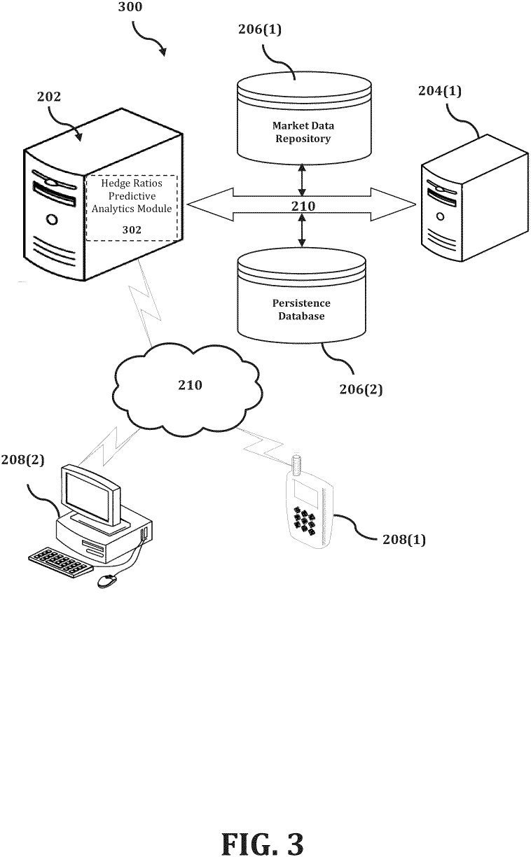

The HRPA device 202 is described and shown in FIG. 3 as including a hedge ratios predictive analytics module 302, although it may include other rules, policies, modules, databases, or applications, for example. As will be described below, the hedge ratios predictive analytics module 302 is configured to implement a method for facilitating real-time predictive analytics of hedge ratios and corresponding durations by using machine learning models.

An exemplary process 300 for implementing a mechanism for facilitating real-time predictive analytics of hedge ratios and corresponding durations by using machine learning models by utilizing the network environment of FIG. 2 is shown as being executed in FIG. 3. Specifically, a first client device 208(1) and a second client device 208(2) are illustrated as being in communication with HRPA device 202. In this regard, the first client device 208(1) and the second client device 208(2) may be “clients” of the HRPA device 202 and are described herein as such. Nevertheless, it is to be known and understood that the first client device 208(1) and/or the second client device 208(2) need not necessarily be “clients” of the HRPA device 202, or any entity described in association therewith herein. Any additional or alternative relationship may exist between either or both of the first client device 208(1) and the second client device 208(2) and the HRPA device 202, or no relationship may exist.

Further, HRPA device 202 is illustrated as being able to access a market data repository 206(1) and a persistence database 206(2). The hedge ratios predictive analytics module 302 may be configured to access these databases for implementing a method for facilitating real-time predictive analytics of hedge ratios and corresponding durations by using machine learning models.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the HRPA device 202 via broadband or cellular communication. Of course, these embodiments are merely exemplary and are not limiting or exhaustive.

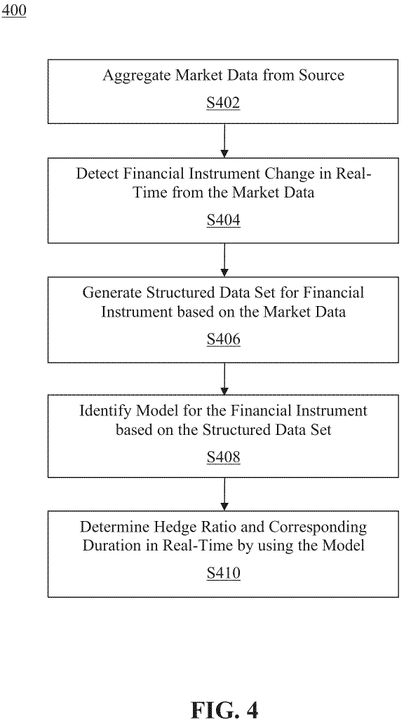

Upon being started, the hedge ratios predictive analytics module 302 executes a process for facilitating real-time predictive analytics of hedge ratios and corresponding durations by using machine learning models. An exemplary process for facilitating real-time predictive analytics of hedge ratios and corresponding durations by using machine learning models is generally indicated at flowchart 400 in FIG. 4.

In the process 400 of FIG. 4, at step S402, market data may be aggregated from a source. The market data may include raw data for a plurality of financial instruments. In an exemplary embodiment, the source may include at least one from among a first-party data source and a third-party data source. The third-party data source may include at least one from among an exchange platform such as, for example, the New York Stock Exchange and a data service provider. The data service provider may aggregate and supply the market data as a service for a fee.

In another exemplary embodiment, the market data may relate to financial information that corresponds to financial instruments of all asset classes on world markets. The financial information may be usable to conduct research and analysis of the financial instruments as well as trading and accounting of the financial instruments. In another exemplary embodiment, the financial instruments may relate to a plurality of hedging financial products that are usable to offset a risk of adverse price movements. The plurality of hedging financial products may include at least one from among a treasury instrument and a swap instrument. For example, the treasury instrument may include treasury bonds, treasury bills, as well as treasury notes and the swap instrument may include derivative contracts.

In another exemplary embodiment, the market data may be aggregated from the source in real-time. The market data may be aggregated such that the market data represents a current state of a corresponding market. In another exemplary embodiment, the market data may be aggregated from the source based on a predetermined criterion. The predetermined criterion may include at least one from among a predetermined schedule and a predetermined user preference. For example, the predetermined schedule may indicate that the market data are aggregated once a day at a set time. Similarly, for example, the predetermined user preference may correspond to an ad hoc request by a user to aggregate the market data.

At step S404, an indication may be detected in real-time from the market data. The indication may relate to a change in the plurality of financial instruments. In an exemplary embodiment, the change in the plurality of financial instruments may correspond to a treasury price change. For example, the change in the plurality of financial instruments may result from a treasury price tick. In another exemplary embodiment, the change in the plurality of financial instruments may correspond to a status change. For example, the change may result from a corresponding transaction of the plurality of financial instruments.

At step S406, a structured data set may be generated for each of the plurality of financial instruments based on the market data. In an exemplary embodiment, to generate the structured data set, the market data may be parsed to identify data elements. The identified data elements may be mapped based on a predetermined data format such as, for example, a tabular data format. Then, the structured data set may be generated based on a result of the mapping. In another exemplary embodiment, the structured data set may correspond to any preprocessing of the raw market data into the predetermined data format.

At step S408, a model for the plurality of financial instruments may be identified based on the structured data set. In an exemplary embodiment, the model may correspond to a particular financial instrument in the plurality of financial instruments. For example, a hedged product model may correspond to and represent properties of hedged products in the plurality of financial instruments. In another exemplary embodiment, the model may correspond to a desired output. For example, a hedge ratio model may correspond to a desired output of hedge ratios and corresponding durations. In another exemplary embodiment, the model may be identified based on a model status such as, for example, a model update status that is usable to identify the most up-to-date model.

In another exemplary embodiment, historical data for each of the plurality of financial instruments may be retrieved based on a predetermined setting. The predetermined setting may relate to a predetermined schedule such as, for example, once a day as well as to a predetermined user preference such as, for example, an ad hoc retrieval of the historical data. A feature that relates to the hedge ratio and the corresponding duration may then be identified from the historical data. The feature may relate to a measurable characteristic of the hedge ratio and the corresponding duration. A historical data pattern that relates to the hedge ratio and the corresponding duration may also be determined from the historical data. Finally, the model may be trained by using the feature and the historical data pattern. As will be appreciated by a person of ordinary skill in the art, the training of the model by using the historical data creates a feedback loop that further refines the model.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, a gradient boosting algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model’s least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S410, a hedge ratio and a corresponding duration may be determined in real-time by using the model. The hedge ratio and the corresponding duration may be determined based on the structured data set. In an exemplary embodiment, the hedge ratio may correspond to a to be announced (TBA) bond instrument. The TBA bond instrument may relate to a forward-settling of mortgage-backed securities trades. As will be appreciated by a person of ordinary skill in the art, the hedge ratio may correspond to any bond instrument and/or securitized product. In another exemplary embodiment, the model may determine a predicted hedge ratio and a corresponding predicted duration in real-time. The predicted hedge ratio and the corresponding predicted duration may relate to a forecasted result that represents the likelihood of a particular outcome.

In another exemplary embodiment, the hedge ratio may compare the value of a position protected through the use of a hedge with the size of the entire position. The hedge ratio may also relate to a comparison of the value of future contracts purchased or sold to the value of the cash commodity being hedged. In another exemplary embodiment, the corresponding duration may relate to a risk exposure duration that is associated with a change in the hedge ratio. For example, the change in hedge ratios may indicate an impact on the risk exposure duration.

In another exemplary embodiment, the determined hedge ratio and the corresponding duration may be used to further train the model. The determined hedge ratio and the corresponding duration may be persisted in a repository as training data. In another exemplary embodiment, documentation may be generated based on the determined hedge ratio, the corresponding duration, and associated data. The documentation may correspond to information and/or evidence that serves as a record of the determining process. The documentation may be associated with the determined hedge ratio and persisted in the repository.

In another exemplary embodiment, a graphical element may be generated. The graphical element may include information that relates to the hedge ratio, the corresponding duration, a threshold value that is associated with the hedge ratio, a detected error, and intraday change data. Then, the graphical element may be displayed via a graphical user interface. In another exemplary embodiment, the graphical element may include information that corresponds to user selectable parameters. For example, a user may select desired parameters to determine the hedge ratio, which are then displayed for the user in the graphical element via the graphical user interface. In another exemplary embodiment, the graphical element may include a visual representation of data such as, for example, a dashboard that displays the included information. The graphical element may be updated in real-time to provide current hedge ratios and corresponding durations.

In another exemplary embodiment, whether the hedge ratio and the corresponding duration exceeds a predetermined user threshold may be determined. The threshold may correspond to a priority level such as, for example, a high-priority level and a low-priority level. A notification may be generated based on a result of the determining. The notification may include information that relates to the hedge ratio, the corresponding duration, the threshold value that is associated with the hedge ratio, a detected error, and intraday change data. Then, a user notification preference may be identified from a corresponding user profile. For example, the user notification preference may indicate that a notification via email is preferred for a high-priority level threshold violation. Finally, the notification may be transmitted via an application programming interface based on the user notification preference.

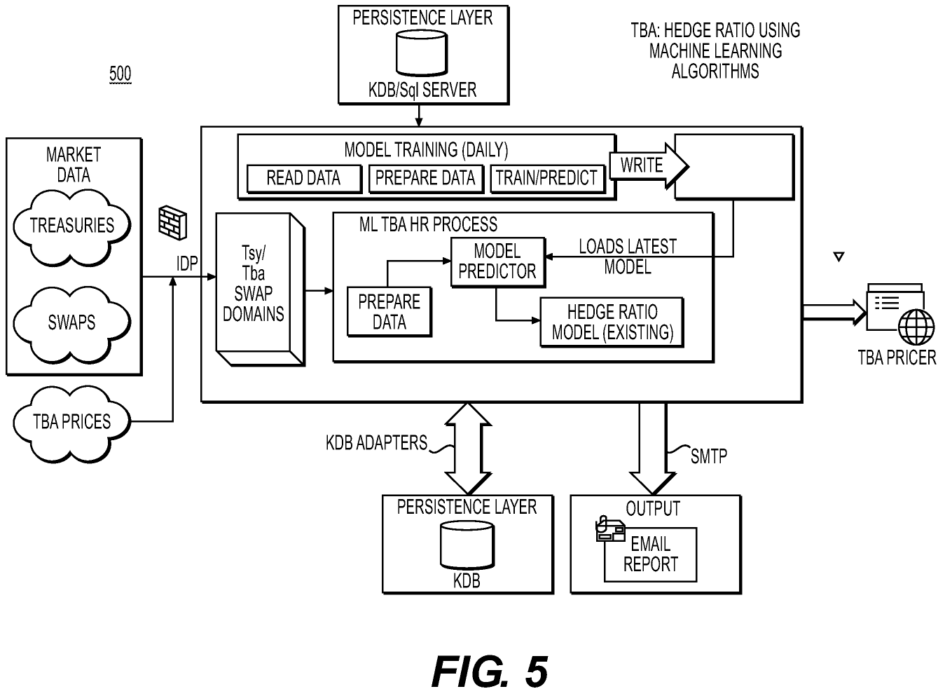

FIG. 5 is a flow diagram 500 of an exemplary process for implementing a method for facilitating real-time predictive analytics of hedge ratios and corresponding durations by using machine learning models. In FIG. 5, a TBA hedge ratio may be determined using machine learning algorithms consistent with disclosures in the present application.

As illustrated in FIG. 5, market data and TBA prices may be aggregated from various sources. The market data may include treasury instrument data and swap instrument data. The market data may be preprocessed for compatibility and inputted into a model predictor. The model predictor may load the latest model from a model training component that aggregates historical data from a persistence layer, preprocesses the historical data, and trains the model.

The model predictor may then use a model such as, for example, the hedge ratio model and the market data to predict a hedge ratio and corresponding duration consistent with disclosures in the present application. An output that includes the predicted hedge ratio and the corresponding predicted duration may be presented via a graphical user interface at a TBA pricing application. The output may also be persisted in a persistence layer by a documentation component as well as transmitted to a user. For example, the output may be transmitted to the user via an email report.

Accordingly, with this technology, an optimized process for facilitating real-time predictive analytics of hedge ratios and corresponding durations by using machine learning models is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating real-time predictive analytics of a plurality of hedge ratios, the method being implemented by at least one processor, the method comprising:
aggregating, by the at least one processor, market data from at least one source, the market data including raw data for a plurality of financial instruments;
detecting, by the at least one processor in real-time from the market data, at least one indication, the at least one indication relating to a change in the plurality of financial instruments;
generating, by the at least one processor, at least one structured data set for each of the plurality of financial instruments based on the market data;
identifying, by the at least one processor, at least one model for the plurality of financial instruments based on the at least one structured data set; and
determining, by the at least one processor in real-time using the at least one model, at least one hedge ratio and a corresponding duration based on the at least one structured data set.

2. The method of claim 1, wherein the plurality of financial instruments relate to a plurality of hedging financial products that are usable to offset a risk of adverse price movements, the plurality of hedging financial products including at least one from among a treasury instrument and a swap instrument.

3. The method of claim 1, wherein the at least one source includes at least one from among a first-party data source and a third-party data source, the third-party data source including at least one from among an exchange platform and a data service provider.

4. The method of claim 1, wherein the change in the plurality of financial instruments corresponds to a treasury price change.

5. The method of claim 1, wherein the at least one hedge ratio corresponds to at least one to be announced bond instrument, the at least one to be announced bond instrument relating to a forward-settling of mortgage-backed securities trades.

6. The method of claim 1, further comprising:
retrieving, by the at least one processor, historical data for each of the plurality of financial instruments based on a predetermined setting;
identifying, by the at least one processor, at least one feature that relates to the at least one hedge ratio and the corresponding duration from the historical data, the at least one feature relating to a measurable characteristic of the at least one hedge ratio and the corresponding duration;
determining, by the at least one processor, at least one historical data pattern that relates to the at least one hedge ratio and the corresponding duration from the historical data; and
training, by the at least one processor using the at least one feature and the at least one historical data pattern, the at least one model.

7. The method of claim 1, further comprising:
generating, by the at least one processor, at least one graphical element, the at least one graphical element including information that relates to the at least one hedge ratio, the corresponding duration, at least one threshold value that is associated with the at least one hedge ratio, at least one detected error, and intraday change data; and
displaying, by the at least one processor via a graphical user interface, the at least one graphical element.

8. The method of claim 1, further comprising:
determining, by the at least one processor, whether the at least one hedge ratio and the corresponding duration exceeds a predetermined user threshold;
generating, by the at least one processor, at least one notification based on a result of the determining, the at least one notification including information that relates to the at least one hedge ratio, the corresponding duration, at least one threshold value that is associated with the at least one hedge ratio, at least one detected error, and intraday change data;
identifying, by the at least one processor, at least one user notification preference from a corresponding user profile; and
transmitting, by the at least one processor via an application programming interface, the at least one notification based on the at least one user notification preference.

9. The method of claim 1, wherein the at least one model includes at least one from among a machine learning model, a statistical model, a mathematical model, a process model, and a data model.

10. A computing device configured to implement an execution of a method for facilitating real-time predictive analytics of a plurality of hedge ratios, the computing device comprising:
a processor;
a memory; and
a communication interface coupled to each of the processor and the memory, wherein the processor is configured to:
aggregate market data from at least one source, the market data including raw data for a plurality of financial instruments;
detect, in real-time from the market data, at least one indication, the at least one indication relating to a change in the plurality of financial instruments;
generate at least one structured data set for each of the plurality of financial instruments based on the market data;
identify at least one model for the plurality of financial instruments based on the at least one structured data set; and
determine, in real-time using the at least one model, at least one hedge ratio and a corresponding duration based on the at least one structured data set.

11. The computing device of claim 10, wherein the plurality of financial instruments relate to a plurality of hedging financial products that are usable to offset a risk of adverse price movements, the plurality of hedging financial products including at least one from among a treasury instrument and a swap instrument.

12. The computing device of claim 10, wherein the at least one source includes at least one from among a first-party data source and a third-party data source, the third-party data source including at least one from among an exchange platform and a data service provider.

13. The computing device of claim 10, wherein the change in the plurality of financial instruments corresponds to a treasury price change.

14. The computing device of claim 10, wherein the at least one hedge ratio corresponds to at least one to be announced bond instrument, the at least one to be announced bond instrument relating to a forward-settling of mortgage-backed securities trades.

15. The computing device of claim 10, wherein the processor is further configured to:
retrieve historical data for each of the plurality of financial instruments based on a predetermined setting;
identify at least one feature that relates to the at least one hedge ratio and the corresponding duration from the historical data, the at least one feature relating to a measurable characteristic of the at least one hedge ratio and the corresponding duration;
determine at least one historical data pattern that relates to the at least one hedge ratio and the corresponding duration from the historical data; and
train, by using the at least one feature and the at least one historical data pattern, the at least one model.

16. The computing device of claim 10, wherein the processor is further configured to:
generate at least one graphical element, the at least one graphical element including information that relates to the at least one hedge ratio, the corresponding duration, at least one threshold value that is associated with the at least one hedge ratio, at least one detected error, and intraday change data; and
display, via a graphical user interface, the at least one graphical element.

17. The computing device of claim 10, wherein the processor is further configured to:
determine whether the at least one hedge ratio and the corresponding duration exceeds a predetermined user threshold;
generate at least one notification based on a result of the determining, the at least one notification including information that relates to the at least one hedge ratio, the corresponding duration, at least one threshold value that is associated with the at least one hedge ratio, at least one detected error, and intraday change data;
identify at least one user notification preference from a corresponding user profile; and
transmit, via an application programming interface, the at least one notification based on the at least one user notification preference.

18. The computing device of claim 10, wherein the at least one model includes at least one from among a machine learning model, a statistical model, a mathematical model, a process model, and a data model.

19. A non-transitory computer readable storage medium storing instructions for facilitating real-time predictive analytics of a plurality of hedge ratios, the storage medium comprising executable code which, when executed by a processor, causes the processor to:
aggregate market data from at least one source, the market data including raw data for a plurality of financial instruments;
detect, in real-time from the market data, at least one indication, the at least one indication relating to a change in the plurality of financial instruments;
generate at least one structured data set for each of the plurality of financial instruments based on the market data;
identify at least one model for the plurality of financial instruments based on the at least one structured data set; and
determine, in real-time using the at least one model, at least one hedge ratio and a corresponding duration based on the at least one structured data set.

20. The storage medium of claim 19, wherein the at least one hedge ratio corresponds to at least one to be announced bond instrument, the at least one to be announced bond instrument relating to a forward-settling of mortgage-backed securities trades.
